(19) United States
(12) Patent Application Publication
(10) Pub. No.: US 2025/0384702 A1
(43) Pub. Date: Dec. 18, 2025

(54) METHOD, DEVICE, AND PRODUCT FOR ITEM DETECTION

(71) Applicant: Dell Products L.P., Round Rock, TX (US)

(72) Inventors: Zijia Wang, London (GB); Wenlei Wu, Shanghai (CN); Zhen Jia, Shanghai (CN); Bin He, Shanghai (CN)

(21) Appl. No.: 18/765,461

(22) Filed: Jul. 8, 2024

(30) Foreign Application Priority Data
Jun. 17, 2024 (CN) 202410780649.3

(51) Int. Cl. G06V 20/64; G06T 7/73; G06V 10/26; G06V 10/74; G06V 10/762; G06V 10/774; G06V 10/776

(52) U.S. Cl. CPC G06V 20/647; G06T 7/75; G06V 10/26; G06V 10/761; G06V 10/762; G06V 10/774; G06V 10/776; G06T 2200/04; G06T 2207/10028; G06T 2207/20081

(57) ABSTRACT

The present disclosure provides a method, a device, and a product for item detection. The method includes acquiring a two-dimensional (2D) representation of an item. The 2D representation may be, for example, a 2D image of the item. The method further includes detecting the item from a three-dimensional (3D) model by using the 2D representation, wherein the 3D model is based on a 3D representation of a system including the item. The method for item detection according to the present disclosure can achieve detection of similar objects across 2D and 3D representations, thereby improving the detection efficiency.

### RELATED APPLICATION

The present application claims priority to Chinese Patent Application No. 202410780649.3, filed Jun. 17, 2024, and entitled “Method, Device, and Product for Item Detection,” which is incorporated by reference herein in its entirety.

### FIELD

Various embodiments described herein relate to the field of item detection, and more specifically, to a method, a device, and a computer program product for item detection.

### BACKGROUND

Item detection is a topic of great interest in the fields of computer vision and multimedia. In a plurality of perception systems such as autonomous driving, robotics, and virtual reality, three-dimensional (3D) tracking is crucial. In addition to these requirements, when new users or junior engineers attempt to install certain servers or other devices, if they can simply take a few photos to map components in their hands with those in a 3D model, the installation process will be more convenient.

However, building a 3D model may involve complex preprocessing steps. In addition, how to pre-train a 3D model in an unsupervised manner and how to extend query-based detection and tracking to 3D are urgent issues that need to be addressed.

### SUMMARY

Therefore, embodiments of the present disclosure provide a method, a device, and a computer program product for item detection. Specifically, embodiments of the present disclosure provide a solution for detecting similar objects across two-dimensional (2D) representations and 3D representations, thereby improving the detection efficiency.

According to one aspect of the present disclosure, a method for item detection is provided. The method includes: acquiring a 2D representation of an item; and detecting the item from a 3D model by using the 2D representation; wherein the 3D model is based on a 3D representation of a system including the item.

According to another aspect of the present disclosure, an electronic device is provided. The electronic device includes at least one processor and a memory, coupled to the at least one processor and storing instructions, wherein the instructions, when executed by the at least one process, cause the electronic device to perform actions comprising: acquiring a 2D representation of an item; and detecting the item from a 3D model by using the 2D representation; wherein the 3D model is based on a 3D representation of a system including the item.

According to still another aspect of the present disclosure, a computer program product is provided. The computer program product is tangibly stored on a non-transitory computer readable medium and includes machine-executable instructions, wherein the machine-executable instructions, when executed by a machine, cause the machine to perform actions comprising: acquiring a 2D representation of an item; and detecting the item from a 3D model by using the 2D representation; wherein the 3D model is based on a 3D representation of a system including the item.

This Summary is provided to introduce relevant concepts in a simplified manner, and these concepts will be further described in the Detailed Description below. The Summary is neither intended to identify key features or essential features of the present disclosure, nor intended to limit the scope of embodiments of the present disclosure.

### BRIEF DESCRIPTION OF THE DRAWINGS

By description of exemplary embodiments of the present disclosure, provided in more detail herein with reference to the accompanying drawings, the above and other objects, features, and advantages of the present disclosure will become more apparent. In the exemplary embodiments of the present disclosure, the same reference numerals generally represent the same elements, and in which.

FIG. 1A is a schematic diagram of an item detection case according to an embodiment of the present disclosure;

FIG. 1B is a schematic diagram of a two-stage framework according to an embodiment of the present disclosure;

FIG. 2 is a flowchart of an example method for item detection according to an embodiment of the present disclosure;

FIG. 3 is a schematic diagram of a pre-training workflow according to an embodiment of the present disclosure;

FIG. 4 is a schematic diagram of a tracker according to an embodiment of the present disclosure; and

FIG. 5 is a block diagram of a device that can be used for implementing embodiments of the present disclosure.

### DETAILED DESCRIPTION

Illustrative embodiments of the present disclosure will be described in more detail below with reference to the accompanying drawings. Although some specific embodiments of the present disclosure are shown in the accompanying drawings, it should be understood that the present disclosure may be implemented in various forms, and should not be limited to the embodiments set forth herein. Rather, these embodiments are provided to make the present disclosure clearer and more complete and can fully convey the scope of the present disclosure to those skilled in the art.

The term “include” and variants thereof used herein indicate open-ended inclusion, that is, “including but not limited to.” Unless specifically stated, the term “or” means “and/or.” The term “based on” means “based at least in part on.” The terms “an example embodiment” and “an embodiment” indicate “at least one example embodiment.” The term “another embodiment” indicates “at least one additional embodiment.” The terms “first,” “second,” and the like may refer to different or identical objects, unless it is clearly stated that the terms refer to different objects.

The following embodiments are examples. Although the specification may mention “an,” “one,” or “some” embodiment(s) in some places, this does not necessarily mean that every such mention refers to the same embodiment, or that the feature only applies to a single embodiment. Individual features of different embodiments may also be combined to provide other embodiments. Furthermore, the words “including” and “containing” should not be construed as an indication that the corresponding embodiment is composed of only those features that have been mentioned, and such an embodiment may also include features/structures that have not been specifically mentioned.

In some example use cases, 3D tracking illustratively involves estimating objects in each frame and determining their temporal correspondence. Given object recognition results for each frame, some 3D tracking arrangements involve determining the similarity among items, and correlation among objects across frames should have consistency. However, the tracking enhances detection stability and ensures inter-frame consistency of detection predictions. But this brings complex iterative optimization challenges. Therefore, a 3D object tracking algorithm that utilizes spatial similarity and appearance similarity in an end-to-end manner is provided in the present disclosure.

Illustrative embodiments of the present disclosure provide an unsupervised pre-training stage based on a Light Detection and Ranging (LiDAR) dataset. A pre-trained model may be used as a feature extractor for 3D trajectory query, for example. The present disclosure further provides a 3D trajectory query, which may directly simulate 3D state and appearance features of object trajectories across cameras and time points. 3D trajectories learn to create, track and/or terminate trajectories by querying sample features from all visible cameras in each frame. Unlike previous approaches, the solution of the present disclosure provides synchronous detection and tracking in a cohesive end-to-end architecture. Objects decoded from the same query across frames are intrinsically linked. The present disclosure also implements edge computing of 3D object detection by introducing a query update mechanism, and the query update mechanism is the basis of intelligent edge offloading.

In view of this, according to the present disclosure, a method, a device, and a computer program product for item detection are provided. Specifically, in some embodiments, a method for item detection is provided. The method includes acquiring a 2D representation of an item. The 2D representation may be, for example, an image of the item. The method further includes detecting the item from a 3D model by using the 2D representation, wherein the 3D model is based on a 3D representation of a system including the item.

The method for item detection according to the present disclosure can achieve similar object detection across 2D and 3D representations, thereby improving the detection efficiency.

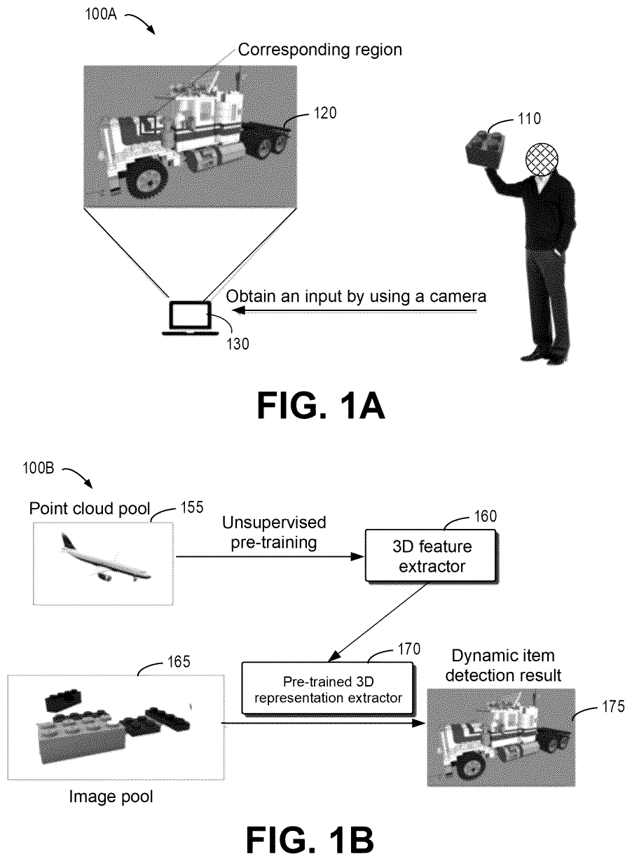

Basic principles and several example embodiments of the present disclosure are described below with reference to FIG. 1A to FIG. 5. It should be understood that these example embodiments are provided merely to enable those skilled in the art to better understand and then implement embodiments of the present disclosure, and are not intended to impose any limitation to the scope of the present disclosure.

FIG. 1A is a schematic diagram of an item detection case 100A according to an embodiment of the present disclosure. The item detection case 100A is illustrated by using a toy model as an example. The item detection case 100A involves a component 110, a toy model 120, and a computer 130. The component 110 is a part on the toy model 120 and is able to and should be installed on the toy model 120. The computer 130 may be used as a server, storing a 3D model of the toy model 120. Specifically, in the computer 130, there is a 3D model of the toy model 120 that has already been constructed. As shown in FIG. 1A, in front of a camera, a user (such as a new user or junior engineer of a toy model) holds a component of the toy model 120 (such as the component 110) and takes a 2D photo of the component 110. According to the methods described in some embodiments of the present disclosure, a position of the component 110 in the 3D model constructed by the toy model 120 may be detected by comparing the 2D photo with the 3D model.

In this way, when the user does not know where the component 110 should be installed in the toy model 120, as long as the 2D photo of the component 110 is taken and used as a query condition to send a query request to the 3D model in the computer 130, the 3D model may tell the user where the component 110 should be installed in the toy model 120, thereby assisting the user in installing the component 110 in the toy model 120. Similarly, when an engineer is assembling a complex large-scale device, if he/she is unsure where a component should be installed on the large-scale device, a similar method may be used to assist with the installation operation by using a pre-established 3D model of the large-scale device.

FIG. 1B is a schematic diagram of a two-stage framework 100B according to an embodiment of the present disclosure. The two-stage framework 100B is used for detecting similar objects across 2D and 3D representations. As shown in FIG. 1B, an unsupervised pre-training stage is first provided to pre-train a 3D representation extractor. Then, in a next stage (that is, an efficient and flexible similar item detection stage, which will be further described later), the pre-trained 3D representation extractor and a query-based object tracking algorithm are utilized for similar item detection.

Specifically, the solution of the present disclosure adopts a pre-training method based on contrastive learning, and achieves improvements and enhancements with respect to the technical issue that the present disclosure aims to solve.

In the visual sense field, contrastive learning strategies have received great attention. These strategies use a small number of labels or no labels to improve the effectiveness of many image-based classification systems. The contrastive learning utilizes data augmentation to generate two unique copies of a single anchor sample, thereby forming a positive pair for the single anchor sample by the two unique copies. Then, a network is trained to discover a representation of features, the similarity between the positive pair is maximized, and similarities to other so-called negative samples are reduced. The contrastive learning is suitable for fine-grained tasks, such as semantic segmentation or object recognition. These techniques use contrastive loss on image segments retrieved by using category independent segmentation techniques. Using the contrastive loss for pre-training or as an auxiliary supervised loss may improve the performance of a network.

Point cloud data is further used for extensive research on autonomous vehicles. By projecting point clouds onto images or developing 3D convolution methods, a convolution process may be applied to point cloud data. Due to the performance of 3D convolution in various tasks such as semantic segmentation and panoptic segmentation, 3D convolution of LiDAR data has received increasing attention. Good results of contrastive learning methods on 2D image data have prompted people to pay attention to use of these methods on 3D data, especially in semantic segmentation and object recognition tasks in autonomous driving. For example, point-wise loss may be used to handle point cloud contrastive learning. However, the point-wise contrastive loss depends on complex preprocessing steps, and the preprocessing is used for constructing a map of corresponding sites between consecutive scans. In addition, by segmenting an image into several spatial partitions, point feature representations and spatial partitioning may be learned, thereby providing additional context for contrastive pre-training. A wider range of contrastive loss may further be provided. A pair of augmented views, that is, a positive pair, may be created for each scan. Then, enhancement scanning is performed on the remaining to be regarded as negative samples, for calculating a contrastive loss of features extracted from the scan.

However, these solutions mentioned above rely on a branch architecture with two backbones, one for points and one for voxels. However, there is no method to focus on point cloud data generated by automotive LiDAR sensors.

Therefore, some embodiments of the present disclosure provide a contrastive representation learning method for outdoor collected autonomous driving LiDAR data. Class-neutral segments are identified from a point cloud, and contrastive loss is applied to derived segments. The presentation learning technique of the present disclosure learns more contextual information by distinguishing segmented structures on the point cloud, and also learns more powerful and descriptive embedding spaces.

Regarding queries in detection and tracking, the detection process is simplified to pixel-wise regression and classifications, and then tracking is performed through linked detection boxes. This is currently one of the most common methods for detecting and tracking objects. Recently, a DEtection Transformer (DETR, an object detection architecture) has achieved significant success in realizing state-of-the-art detection results through the use of query-based set prediction. The concept is ultimately extended to online 2D Multiple Object Tracking (MOT) by TrackFormer, MOTR, and TransTrack (all of which are item detection architectures). The query-based tracking architecture is the foundation of the present disclosure. Some of the technical solutions of the present disclosure further extend the framework to support multi-camera 3D object tracking.

Therefore, some embodiments of the present disclosure mainly focus on how to pre-train a model in an unsupervised manner (as mentioned above, using a small number of labels or no labels), and how to extend query-based detection and tracking to 3D and multi-camera settings.

Specifically, in FIG. 1B, the two-stage framework 100B involves a point cloud pool 155, a 3D feature extractor 160, an image pool 165, a pre-trained 3D representation extractor 170, and a dynamic item detection result 175.

As shown in FIG. 1B, first, the point cloud pool 155 of an item (for example, the component 110 shown in FIG. 1A) is acquired. The point cloud pool 155 may be considered as a set of point cloud data, such as outdoor LiDAR data. Based on the point cloud pool 155, the 3D feature extractor 160 is subject to unsupervised pre-training, through which the pre-trained 3D representation extractor 170 is obtained.

By using the pre-trained 3D representation extractor 170, the dynamic item detection result 175 can be obtained for images in the image pool 165. For example, the images in the image pool 165 may be 2D images taken of a toy model (for example, the toy model 120 shown in FIG. 1A), and these 2D images are associated with specific positions on the toy model and thus also associated with specific positions on a 3D model of the toy model. In other words, as long as a 2D photo of a certain component (such as the component 110 shown in FIG. 1A) matches a certain image in the image pool 165, by comparing the 2D image with the 3D model of the toy model, a correct installation position of the component on the toy model can be determined. In this way, by taking a 2D photo of a certain (to-be-installed) component (such as the component 110 shown in FIG. 1A) of the toy model and using it as a query condition to query the pre-trained 3D model of the toy model, the correct installation position of the component on the toy model can be acquired through the pre-trained 3D model. In this way, the installation of the toy model can be easily and quickly completed.

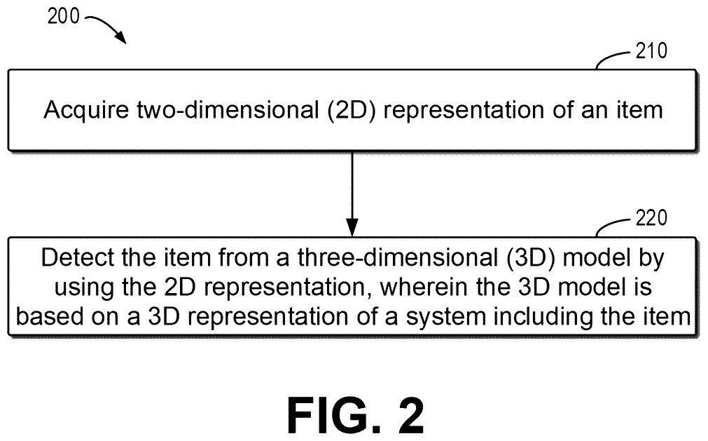

FIG. 2 is a flowchart of an example method 200 for item detection according to an embodiment of the present disclosure. As shown in FIG. 2, in the example method 200, at 210, a 2D representation of an item (for example, the component 110 shown in FIG. 1A) is acquired, wherein the 2D representation is, for example, a 2D photo of the item. At 220, the item is detected from a 3D model by using the 2D representation. The 3D model is based on a 3D representation of a system including the item (for example, the toy model 120 shown in FIG. 1A). The 3D representation may be 3D point cloud data, specifically, for example, it may be outdoor LiDAR point cloud data. The 3D model can, for example, eliminate ground points based on the point cloud data through unsupervised learning, and cluster the point cloud data after the ground points are eliminated to obtain segments of the item and segments of the system. In other words, the technical solutions of some embodiments of the present disclosure utilize a two-stage framework (for example, the two-stage framework 100B shown in FIG. 1B) to perform similar object detection across 2D and 3D representations. The 3D model is established first through unsupervised pre-training to obtain a pre-trained 3D representation extractor. Then, the 3D representation extractor is utilized for efficient and flexible similar item detection.

In the method 200, the unsupervised learning may include contrastive learning, and in the contrastive learning, two distinct copies may be generated for an anchor sample in 3D-based point cloud data to form a positive pair, while maximizing the similarity between the positive pair and reducing the similarities to negative samples in the 3D representation. The contrastive learning may use point-wise loss for supervision. The unsupervised learning may not use labels.

In order to improve the accuracy of the object detection, the 2D representation may also be segmented to obtain image segments, and contrastive loss may be applied to the image segments.

In the method 200, in order to detect the item by using the 2D representation, a set of new queries may be created at the beginning of each frame based on the 2D representation. A 3D reference point is used to sample image features of the 2D representation, and a motion model is used to evaluate dynamics of the item, thereby updating the 3D reference point. Based on the new query, the corresponding position of the item in the 3D model may be determined.

In the method 200, for the new query in a first frame, if a score is lower than a first threshold, the first frame may be deleted. Alternatively, if scores of a plurality of consecutive frames are lower than a second threshold, the plurality of consecutive frames may be deleted.

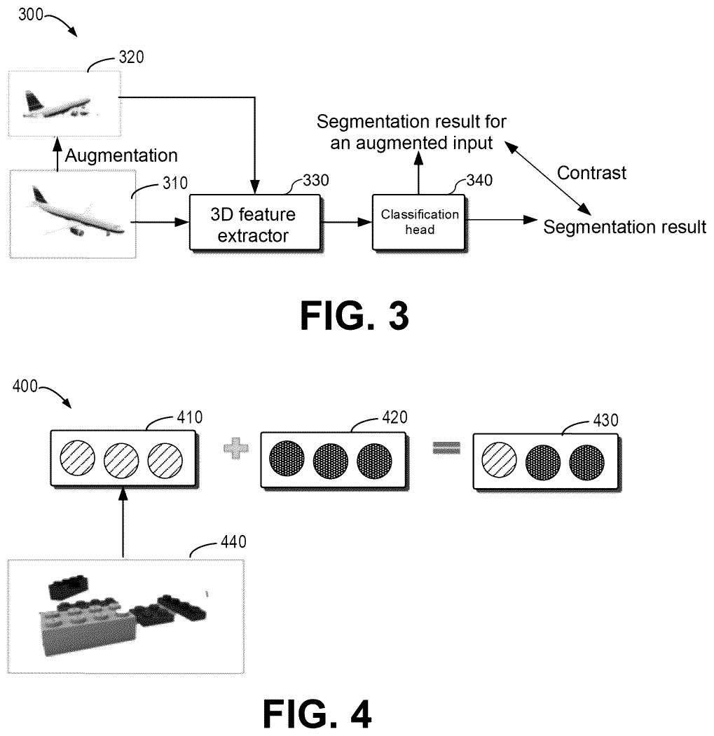

FIG. 3 is a schematic diagram of a pre-training workflow 300 according to an embodiment of the present disclosure. As shown in FIG. 3, some embodiments of the present disclosure rely on point cloud segments representing different structures. In outdoor LiDAR data, most items in a scene are related through the ground and are usually clearer than an item in an indoor scene. Considering this characteristic, the ground may be eliminated first, and then remaining points may be clustered. In this way, extracting unlabeled segments in two stages becomes very simple and feasible.

Given an input point cloud P (denoted by reference numeral 310 in FIG. 3) and its augmented pair P_{q} (denoted by reference numeral 320 in FIG. 3) and Pₖ (for simplicity, the illustration is omitted in FIG. 3), a backbone is used to calculate respective point-wise features F_{q} and Fₖ of the augmented pair P_{q} and Pₖ. The entire point cloud is used to learn relationships between segments and scenes in a forward propagation process of the backbone. Then, a 3D feature extractor 330 and a classification head 340 are used to extract augmented segments S_{q} and Sₖ respectively corresponding to the augmented pair P_{q} and Pₖ, as well as their point-wise features, from the point cloud. For example, in the embodiment shown in FIG. 3, due to the omission of the illustration of Pₖ in the augmented pair, after passing through the classification head 340, a segmentation result corresponding to the point cloud P is obtained as shown by the rightward arrow. Meanwhile, as indicated by the upward arrow, a segmentation result corresponding to the point cloud P_{q} in the augmented pair is obtained. Next, dropout and global max-pooling are applied on each segment to calculate a feature vector. Then, the feature vector is passed through a projection head to obtain segmented feature vectors s_{qm} and sₖₘ. The segmentation result corresponding to the point cloud P is contrasted to (compared with) the segmentation result corresponding to the point cloud P_{q}, and the contrastive loss is calculated.

Given the point cloud P={p₁, . . . , p_{N}}, wherein |P|=N, and point pᵢ∈ [symbol] , a ground plane may be fitted and the point cloud is divided into the ground G and non-ground points P′, so that P=P′∪G and P′∩G=Ø. Then, by using a clustering algorithm, P′ may be divided into M segments Sₘ, so that

$${P}^{′} = {⋃}_{m = 1}^{M} {S}_{m} and {⋂}_{m = 1}^{M} {S}_{m} = ∅ ,$$

that is, the segments are mutually exclusive. Each segment Sₘ in the partition represents a structure different from the original point cloud.

Specifically, random sample consensus (RANSAC) may be used to fit the ground plane and define ground and non-ground points G and P′. An inner point (ground) and an outer point (non-ground) are separated based on the fitting plane and a distance threshold a. Clustering is performed on the non-ground points P′ by using density-based spatial clustering of applications with noise (DBSCAN) and Sₘ segments are identified.

Over-segmentation and under-segmentation are typical problems of category independent segmentation. To avoid the problem and extract representative segments, ¿ may be defined as the minimum number of points forming a segment in a cluster. In addition, the number of segments varies each time the point cloud is segmented, and therefore, a delta segment with the maximum number of points may be selected to prevent memory overflow during training. In addition, the remaining segments are added to the ground point set G. Although the segmentation method is simple, it may divide the scene into different components. After running the point cloud for the first time, the segments may be cached to reduce the required computation during training.

For example, each point may be assigned to a segment, and data augmentation may be applied to generate a segment augmentation pair S_{q} and Sₖ corresponding to the augmentation pair Pa and Pₖ. Random views P_{q} and Pₖ may be extracted by cropping random rectangular regions from the anchor point cloud P, and the random views P_{q} and Pₖ are also point clouds. Then, random augmentation may be applied separately on the point clouds P_{q} and Pₖ. Regarding methods for augmentation, for example, random rotation, random scaling, random flipping, random box loss, point jitter, and rotation perturbations around x, y, and z axes may be used to augment the views. All augmentations are combined and applied once to each augmented view P_{q} and Pₖ.

By extracting a pair of views and enhancing the point cloud, the augmentation may be implicitly applied to the extracted segments. Due to the retention of point segment allocation through point indexing during augmentation, it is easy to extract S_{q} and Sx from the augmented views and calculate the contrastive loss. The purpose of a contrastive loss function is to distinguish between the positive pair and the negative pair. For example, InfoNCE loss, momentum encoder, and feature library may be used in the present disclosure.

As mentioned earlier, in some embodiments of the present disclosure, two augmented views P_{q} and Pₖ from the anchor cloud P are adopted. Point-wise features F_{q} and Fₖ may be calculated from the two augmented views, and augmented segments S. and Sₖ may be extracted from them. Then, the segments may pass through the projection head to calculate segmented feature vectors s_{qm} and sₖₘ. Therefore, the contrastive loss may be defined as a segmentation discrimination rule, that is, segmentation based on contrastive loss. For example, when the contrastive loss is lower than a first threshold, they are classified as the same class, and when the contrastive loss is higher than a second threshold, they are classified as different classes.

At the end of each iteration, the feature library is updated using the segmented features of the current batch, retaining only the last K segments visible to the network. After pre-training, the pre-trained model may be used, as a 3D feature extractor, for 3D item detection based on 2D images.

According to some embodiments of the present disclosure, algorithms utilize query-based tracking. The query-based tracking is an extension of query-based detection, wherein the detection query is a fixed-sized embedded set representing 2D object candidates. The trajectory query extends the concept of detection query across a plurality of frames, that is, expresses the entire trajectory across frames. Specifically, a set of new queries is created at the beginning of each frame, and then the queries update themselves frame by frame in an autoregressive manner. A decoder head predicts a potential item for each track query in each frame, and directly connects decoding boxes in different frames from the same track query. The query-based tracking may achieve online joint detection and tracking through proper query lifecycle management. The query-based multi-camera 3D tracker consists of three important components. The query-based object tracking loss sets different regression objectives for two different types of queries (new queries and old queries). Meanwhile, multi-camera sparse attention uses 3D reference points to sample image features of each query. A motion model may be utilized to evaluate dynamics of items and change reference points for query between frames.

FIG. 4 is a schematic diagram of a tracker 400 according to an embodiment of the present disclosure. The tracker 400 in this embodiment processes new queries 410, old queries 420 and combined queries 430, relating to an image or image pool 440. Firstly, label allocation is defined in a query-based tracking context. An algorithm of the present disclosure preserves a constantly changing set of cross-frame tracking query iterations. A candidate object is decoded for each query at a current frame. Ideally, decoding object candidates from the same query should represent the same cross-frame object, thus generating a complete trajectory. In order to train a query-based tracker, a real object is designated as a regression target for each query in each frame. In some embodiments, the label allocation is a function of mapping a real object to a tracking query. Usually, Ø (no object) is used to fill a ground truth object set to the number of predicted object candidates to ensure that mapping is one-to-one mapping. Assuming that in the current frame, there are N decoded candidate objects {y¹, . . . y^{N}}, the label allocation may be represented as mapping π∈{1, 2 . . . , N}= [symbol] {1, 2 . . . , N}. Therefore, the training loss may be expressed as the sum of pairing box losses.

Each frame has two different types of queries, and the label allocation process for each type of query varies. They do not rely on any specific input and will be added to a query list before the start of each frame. A new task is determining the identity of a thing that has recently appeared in the current frame. Therefore, as a DETR, binary matching is performed between candidate objects from new queries and newly appearing ground truth items. The term “old queries” refers to continuous queries that may be traced back to previous time periods and successfully locate or track things. The items that appeared in the frame in the past are the focus of detection in the old queries. The allocation of earlier queries is determined immediately after the first successful identification of a real item (a ground truth item). If the real item is visible in both the target frame and the current frame, it may be tracked along with the target; otherwise, Ø (no item is detected).

The 3D box loss [symbol] _{box} in the present disclosure is defined as follows:

$${ℒ}_{b o x} ( {y}_{π ( i )} , {\hat{y}}_{j} ) = \{ \begin{matrix}{L}_{cls} ( {c}_{π ( i )} , {\hat{c}}_{j} ) + λ {L}_{reg} ( {b}_{π ( i )} , {\hat{b}}_{j} ) & {y}_{π ( i )} \neq ∅ \\ {L}_{cls} ( {c}_{π ( i )} , {\hat{c}}_{j} ) & {y}_{π ( i )} = ∅\end{matrix}$$

L₁ loss is used for L_{reg}, L_{cls} is the focus loss, and the 3D object y_{π(i)} is parameterized by using a class label c_{π(i)} and a bounding box parameter b_{π(i)}.

For query feature extraction, the use and working principle of cross attention is to project the reference point of each query onto all camera and sampling point features. It is assumed that there are synchronized images for each frame from M cameras. Pyramid features are independently extracted for each image. A pyramid feature set is represented as: F₁, F₂, F₃, F₄. Each item Fₖ={Fₖ₁, . . . , F_{kM}}, and Fₖᵢ ∈ [symbol] corresponds to the feature level of M images. The provided camera projection matrix is represented as T={T₁, . . . , T_{M}}, Tᵢ∈ [symbol] . Specifically, the sampling point feature f_{c}_{ᵢ} is computed as follows:

$${c}_{m i} = {{T}_{m} ( {c}_{i} ⊕ 1 )}_{j} , {w}_{i} = M L P ( {q}_{i} ) ,$$

$${f}_{{c}_{i}} = {\sum }_{k}^{4} {\sum }_{m}^{M} {F}_{k m} ( {c}_{m i} ) \cdot σ ( {w}_{k m i} ) ,$$

wherein cₘᵢ represents the two-dimensional coordinates of a projection of a camera m on the image plane, Fₖₘ(cₘᵢ) represents bilinear sampling of image features, and σ( ) represents a sigmoid function used for standardizing weight factors. Then, the extracted features are used to update the query and its reference points.

$${q}_{i} ← {q}_{i} + MLP ( {f}_{{c}_{i}} + P E ( {q}_{i} ) ) ,$$

$${c}_{i} ← {c}_{i} + MLP ( {f}_{{c}_{i}} ) ,$$

wherein PE is a learnable positional encoding that is initialized with each query. After undergoing layers of Transformer decoders, the final query features are used to decode candidate objects in the current frame.

For 3D object parameterization, two small Feed-forward Neural Networks (FFNs) are used to decode 3D box parameters and classification labels. The 3D box is parameterized with additional parameters in ten dimensions: the coordinates of a center of the box in an ego frame, xᵢ∈ [symbol] , the size of the 3D box being sᵢ=(wᵢ, lᵢ, hₜ) ∈ [symbol] , the 2D velocity in the ego frame being vᵢ=(vᵢₓ, v_{iy}) ∈ [symbol] , and the direction being (sin θᵢ; cos θᵢ), wherein θ; is the yaw angle in the ego coordinate system. The coordinates of the box center are predicted by adding residuals to the reference point:

$${x}_{i} = {c}_{i} + M L P ( {q}_{i} )$$

It is worth noting that in some embodiments of the present disclosure, the original workflow is extended to handle a plurality of cameras, but in the case shown in FIG. 1, only one image needs to be processed for each frame.

In the present disclosure, as shown in FIG. 4, a query queue of each frame may be updated iteratively, which can avoid repeated calculation and can realize edge computing of 2D-to-3D object detection. To cope with disappearing items online, it is necessary to delete idle queries after each frame. A confidence score of each query may be defined as a classification score of its expected box. Two threshold parameters, τ_{new} and τ_{old}, may also be used to represent box scores, and the time length T may be used to control lifespan management.

During an inference process, for a new query in each frame, if the score is lower than τ_{new}, it is deleted. For an old query, if scores of consecutive T frames are lower than τ_{old}, they are deleted. After multiple experiments, it is selected for a nuScenes dataset that τ_{new}=0.4, τ_{old}=0.35, and T=5.

To implicitly model appearance changes of a plurality of frames, trajectory queries may be updated using the features of previous frames. Following MOTR, a fixed-sized first in first out (FIFO) queue is maintained for each activity query, which is referred to as a memory library. After each frame, an attention module is applied to the memory library of each query. The trajectory query serves as a query for the attention module, and the corresponding memory library serves as a set of keys and values.

In general, the present disclosure provides a multi-stage framework for detecting similar objects across 2D and 3D representations. In the present disclosure, an unsupervised pre-training algorithm is provided in a first stage of the framework, and uses LiDAR data to pre-train a 3D representation extractor. Then, a similar object detection stage is provided using query-based detection and tracking. The similar object detection stage follows the unsupervised pre-training stage in the framework, and the unsupervised pre-training stage performs pre-training based on unsupervised 3D point cloud segmentation and can train the 3D model to the maximum extent. In addition, by choosing to use the LiDAR data, the process may be completely unsupervised. The similar object detection stage supports edge computing. In this way, the similar object detection framework is very efficient and flexible. The present disclosure provides a pre-training model and applies it to edge computing in similar target detection across 2D and 3D representations. The method provided in the present disclosure may be easily extended to other applications, for example, 3D segmentation, autonomous driving services, and the like.

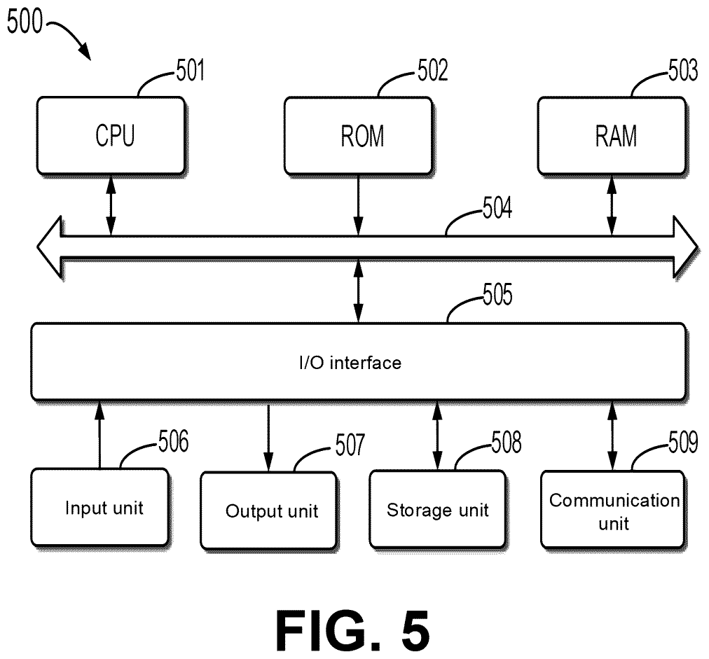

FIG. 5 is a block diagram of a device 500 that may be used to implement an embodiment of the present disclosure. The device 500 may be a device, an apparatus, or a system described in embodiments of the present disclosure. For example, the device 500 may be any hardware that is used for implementing the method according to the present disclosure, such as a server and a device (such as a terminal device). As shown in FIG. 5, the device 500 includes a central processing unit (CPU) 501 which may perform various appropriate actions and processing according to computer program instructions stored in a read-only memory (ROM) 502 or computer program instructions loaded from a storage unit 508 to a random access memory (RAM) 503. The RAM 503 may further store various programs and data required by operations of the device 500. The CPU 501, the ROM 502, and the RAM 503 are connected to each other through a bus 504. An input/output (I/O) interface 505 is also connected to the bus 504.

A number of components in the device 500 are connected to the I/O interface 505, including: an input unit 506, such as a keyboard or a mouse; an output unit 507, such as various types of displays or speakers; the storage unit 508, such as a magnetic disk and an optical disc; and a communication unit 509, such as a network card, a modem, or a wireless communication transceiver. The communication unit 509 allows the device 500 to exchange information/data with other devices via a computer network such as the Internet and/or various telecommunication networks.

The various methods or processes described above may be performed by the CPU 501. For example, in some embodiments, the method may be implemented as a computer software program that is tangibly included in a machine-readable medium, such as the storage unit 508. For example, in some embodiments, the method of the present disclosure may be embodied as a computer software program that is tangibly included in a machine-readable medium, such as the storage unit 508. In some embodiments, part of or all the computer program may be loaded and/or installed to the device 500 via the ROM 502 and/or the communication unit 509. When the computer program is loaded into the RAM 503 and executed by the CPU 501, one or more steps or actions of the method or process described above may be executed.

As stated above, a method for item detection is provided in the present disclosure. According to the method, a 2D representation of the item is acquired. The 2D representation may be, for example, a 2D image of the item. Then, the item is detected from a 3D model by using the 2D representation, wherein the 3D model is based on a 3D representation of a system including the item.

As mentioned above, the method for item detection according to the present disclosure can achieve similar object detection across 2D and 3D representations, thereby improving the detection efficiency.

In some embodiments, the methods and processes described above may be implemented as a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electrical storage device, a magnetic storage device, an optical storage device, an electromagnetic storage device, a semiconductor storage device, or any suitable combination thereof. More specific examples (a non-exhaustive list) of the computer-readable storage medium include: a portable computer disk, a hard disk, a RAM, a ROM, an crasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices, or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for performing the operations of the present disclosure may be assembly instructions, Instruction Set Architecture (ISA) instructions, machine instructions, machine-related instructions, microcode, firmware instructions, status setting data, or source code or item code written in any combination of one or more programming languages, including object-oriented programming languages as well as conventional procedural programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer can be connected to a user computer through any kind of networks (including a local area network (LAN) or a wide area network (WAN)) or can be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

These computer-readable program instructions can be provided to a processing unit of a general-purpose computer, a special-purpose computer, or another programmable data processing apparatus to produce a machine, such that these instructions, when executed by the processing unit of the computer or another programmable data processing apparatus, generate an apparatus for implementing the functions/actions specified in one or more blocks in the flowcharts and/or block diagrams. The computer-readable program instructions may also be stored in a computer-readable storage medium. These instructions cause a computer, a programmable data processing apparatus, and/or another device to operate in a particular manner, such that the computer-readable medium storing the instructions includes an article of manufacture which includes instructions for implementing various aspects of the functions/actions specified in one or more blocks in the flowcharts and/or block diagrams.

The computer-readable program instructions can be loaded onto a computer, other programmable data processing apparatuses, or other devices, so that a series of operating steps are performed on the computer, other programmable data processing apparatuses, or other devices to produce a computer-implemented process. Therefore, the instructions executed on the computer, other programmable data processing apparatuses, or other devices implement the functions/actions specified in one or more blocks in the flowcharts and/or block diagrams.

The flowcharts and block diagrams in the accompanying drawings show the architectures, functions, and operations of possible implementations of the device, the method, and the computer program product according to a plurality of embodiments of the present disclosure. In this regard, each block in the flowcharts or block diagrams may represent a module, a program segment, or part of an instruction, the module, program segment, or part of an instruction including one or more executable instructions for implementing specified logical functions. In some alternative implementations, the functions denoted in the blocks may also occur in an order different from that shown in the drawings. For example, two consecutive blocks may in fact be executed substantially concurrently, and sometimes they may also be executed in a reverse order, depending on the functions involved. It should be further noted that each block in the block diagrams and/or flowcharts as well as a combination of blocks in the block diagrams and/or flowcharts may be implemented by a dedicated hardware-based system executing specified functions or actions, or by a combination of a dedicated hardware and computer instructions.

Various embodiments of the present disclosure have been described above. The above description is illustrative, rather than exhaustive, and is not limited to the disclosed various embodiments. Numerous modifications and alterations will be apparent to persons of ordinary skill in the art without departing from the scope and spirit of the illustrated embodiments. The selection of terms as used herein is intended to best explain the principles and practical applications of the various embodiments and their associated technical improvements, so as to enable persons of ordinary skill in the art to understand the embodiments disclosed herein.

What is claimed is:

1. A method for item detection, comprising:
acquiring a two-dimensional (2D) representation of an item; and
detecting the item from a three-dimensional (3D) model by using the 2D representation;
wherein the 3D model is based on a 3D representation of a system comprising the item.

2. The method according to claim 1, wherein the 3D representation comprises point cloud data, the 3D model eliminates ground points through unsupervised learning based on the point cloud data, and clusters the point cloud data after the ground points are eliminated to obtain segments of the item and segments of the system.

3. The method according to claim 2, wherein the unsupervised learning comprises contrastive learning, two distinct copies are generated based on one anchor sample in the point cloud data in the contrastive learning to form a positive pair, a similarity between the positive pair is maximized, and a similarity to a negative sample in the 3D representation is reduced.

4. The method according to claim 2, further comprising:
segmenting the 2D representation to obtain image segments; and
applying contrastive loss to the image segments.

5. The method according to claim 3, wherein the contrastive learning uses point-wise loss for supervision.

6. The method according to claim 1, wherein detecting the item by using the 2D representation comprises:
creating a set of new queries based on the 2D representation at a beginning of each frame;
sampling, by using a 3D reference point, image features of the 2D representation; and
evaluating dynamics of the item through a motion model and updating the 3D reference point.

7. The method according to claim 6, further comprising:
determining, based on the new queries, a corresponding position of the item in the 3D model.

8. The method according to claim 6, further comprising at least one of the following:
for the new query in a first frame, deleting the first frame if a score is lower than a first threshold; or
deleting a plurality of consecutive frames if scores of the plurality of consecutive frames are lower than a second threshold.

9. The method according to claim 2, wherein the unsupervised learning does not use labels.

10. The method according to claim 2, wherein the point cloud data comprises outdoor LiDAR point cloud data.

11. An electronic device, comprising:
at least one processor; and
a memory, coupled to the at least one processor and storing instructions, wherein the instructions, when executed by the at least processor, cause the electronic device to perform actions comprising:
acquiring a two-dimensional (2D) representation of an item; and
detecting the item from a three-dimensional (3D) model by using the 2D representation;
wherein the 3D model is based on a 3D representation of a system comprising the item.

12. The electronic device according to claim 11, wherein the 3D representation comprises point cloud data, the 3D model eliminates ground points through unsupervised learning based on the point cloud data, and clusters the point cloud data after the ground points are eliminated to obtain segments of the item and segments of the system.

13. The electronic device according to claim 12, wherein the unsupervised learning comprises contrastive learning, two distinct copies are generated based on one anchor sample in the point cloud data in the contrastive learning to form a positive pair, a similarity between the positive pair is maximized, and a similarity to a negative sample in the 3D representation is reduced.

14. The electronic device according to claim 12, wherein the actions further comprise:
segmenting the 2D representation to obtain image segments; and
applying contrastive loss to the image segments.

15. The electronic device according to claim 13, wherein the contrastive learning uses point-wise loss for supervision.

16. The electronic device according to claim 11, wherein detecting the item by using the 2D representation comprises:
creating a set of new queries based on the 2D representation at a beginning of each frame;
sampling, by using a 3D reference point, image features of the 2D representation; and
evaluating dynamics of the item through a motion model and updating the 3D reference point.

17. The electronic device according to claim 16, wherein the actions further comprise:
determining, based on the new queries, a corresponding position of the item in the 3D model.

18. The electronic device according to claim 16, wherein the actions further comprise at least one of the following:
for the new query in a first frame, deleting the first frame if a score is lower than a first threshold; or
deleting a plurality of consecutive frames if scores of the plurality of consecutive frames are lower than a second threshold.

19. The electronic device according to claim 12, wherein the point cloud data comprises outdoor LiDAR point cloud data.

20. A computer program product, the computer program product being tangibly stored on a non-transitory computer readable medium and comprising machine-executable instructions, wherein the machine-executable instructions, when executed by a machine, cause the machine to perform actions comprising:
acquiring a two-dimensional (2D) representation of an item; and
detecting the item from a three-dimensional (3D) model by using the 2D representation;
wherein the 3D model is based on a 3D representation of a system comprising the item.
